(19) United States
(12) Patent Application Publication
(10) Pub. No.: US 2013/0033622 A1
(43) Pub. Date: Feb. 7, 2013

(54) METHOD AND APPARATUS FOR MOTION ARTIFACT CORRECTION IN HDR VIDEO

(71) Applicant: DONG LI, Cupertino, CA (US)

(72) Inventor: DONG LI, Cupertino, CA (US)

(73) Assignee: APTINA IMAGING CORPORATION, George Town Grand Cayman (KY)

(21) Appl. No.: 13/275,569

(22) Filed: Oct. 18, 2011

Related U.S. Application Data
(60) Provisional application No. 61/515,061, filed on Aug. 4, 2011.

(51) Int. Cl. H04N 5/217

(52) U.S. Cl. 348/241; 348/E05.078

(57) ABSTRACT

A method and system of correcting motion artifacts are provided for video captured from interlaced multiple exposure sensors. The following are included: (a) motion artifacts detection of a pixel area, (b) smoothing of the detected pixel area, and (c) motion artifacts correction. The motion artifacts pixels are detected by comparing the luma difference between a current image frame and a previous image frame; the pixels of the surrounding area are also checked. A smoothing operation is applied to the detected artifacts area, in order to remove isolated pixels and enlarge the detected area. Corrections are then provided using a multistage filter for the luma channel and a mean filter for the chroma channel.

### CROSS REFERENCE TO RELATED APPLICATIONS

This application claims priority of U.S. Provisional Patent Application Ser. No. 61/515,061, filed Aug. 4, 2011, which is incorporated herein by reference.

### FIELD OF THE INVENTION

The present invention relates, in general, to image sensors, and more particularly, to correcting motion artifacts in high dynamic range (HDR) images having interlaced exposure.

### BACKGROUND OF THE INVENTION

Modern electronic devices such as cellular telephones, cameras, and computers often use digital image sensors, such as high dynamic range image sensors. Image sensors may sometimes be referred to herein as images. High dynamic range imagers are designed to capture scenes with light ranges that exceed the typical dynamic range of an individual linear pixel or an analog-to-digital converter. The dynamic range of a pixel can be defined as the ratio of minimum luminance or brightness in an image, which causes the pixel to saturate, to the brightness in an image, which achieves a signal-to-noise ratio (SNr) equal to one. The dynamic range of a scene can be expressed as the ratio of its highest illumination level to its lowest illumination level.

Examples of techniques for capturing high dynamic range images include combining multiple exposures of varying exposure times, utilizing partial reset level techniques, and providing pixels with logarithmic or other non-linear responses. With a multiple exposure technique, an image sensor takes a first long exposure and then takes a second short exposure. The two exposures are then combined into a high dynamic range image. Because the two exposures are taken at different times, however, the fast moving objects within a scene cannot be captured at the same spatial location. This leads to pronounced motion artifact in a reconstructed image.

As will be explained, the present invention improves on a method for capturing HDR image data that uses an interleaved, or interlaced HDR (iHDR) multiple exposure technique. This technique reduces motion artifacts. However, when a moving object and its corresponding background have very different brightness levels, motion artifacts are still present in the reconstructed images. Such motion artifact is disturbing to human eyes. As will also be explained, the present invention combines motion artifact detection with a correction filter to reduce the motion artifacts in the HDR captured video.

### BRIEF DESCRIPTION OF THE DRAWINGS

This invention is best understood from the following detailed description when read in connection with the accompanying figures:

FIG. 1 is a schematic diagram of an illustrative electronic device that may include high dynamic range image sensing circuitry in accordance with an embodiment of the present invention.

FIG. 2 is a schematic diagram of an illustrative array of pixels and control circuitry coupled to the array of pixels in accordance with an embodiment of the present invention.

FIG. 3 is a schematic diagram of an illustrative light-sensitive pixel that may be a part of high dynamic range image sensing circuitry in accordance with an embodiment of the present invention.

FIG. 4 is a diagram of an illustrative color filter array and an array of pixels that may include pairs of row of pixels that alternate between a short and a long exposure time and that can be used to capture a high dynamic range image in accordance with an embodiment of the present invention.

FIG. 5 is a diagram of the illustrative color filter array and the array of the pixels of FIG. 4 showing how two separate reset pointers may be used to initiate the long and short exposure times when the array of pixels is being used to capture a high dynamic range image in accordance with an embodiment of the present invention.

FIG. 6 is a diagram of illustrative line buffers and image processing circuitry that may be used in forming a high dynamic range image from image data received from an array of pixels such as the array of FIG. 4 in accordance with an embodiment of the present invention.

FIG. 7 is a timing diagram of an illustrative color filter array and an array of pixels the may include rows of pixels that alternate between a short and a long exposure time and that can be used to capture a high dynamic range image in accordance with an embodiment of the present invention.

FIG. 8 is a diagram of a moving hand in a very bright background.

FIG. 9 is a diagram of two reconstructed images based on interpolating interlaced exposures of T1 data and T2 data in a high dynamic range.

FIG. 10 is a block diagram of an artifact correction system, in accordance with an embodiment of the present invention.

FIG. 11 depicts examples of one-dimensional filtering applied along directions of horizontal, vertical, 135 degrees and 45 degrees, in accordance with an embodiment of the present invention.

### DETAILED DESCRIPTION OF THE INVENTION

High dynamic range (HDR) image capture may be performed using sequential multiple image captures with varying exposure times. Multi-frame capture HDR often suffers from motion artifacts in final reconstructed images, because each exposure is captured at a different instance in time. The present invention combines a multi-frame capture method that reduces motion artifacts in HDR reconstructed images with a filtering method that further reduces the motion artifacts. The present invention detects motion artifacts in an HDR image, in which a moving object has a very different brightness level than its corresponding background. For example, a hand moving against a strong lighting background in a window may be detected by the present invention as a motion artifact. As will be explained, the detected motion artifact is smoothed and corrected by the present invention.

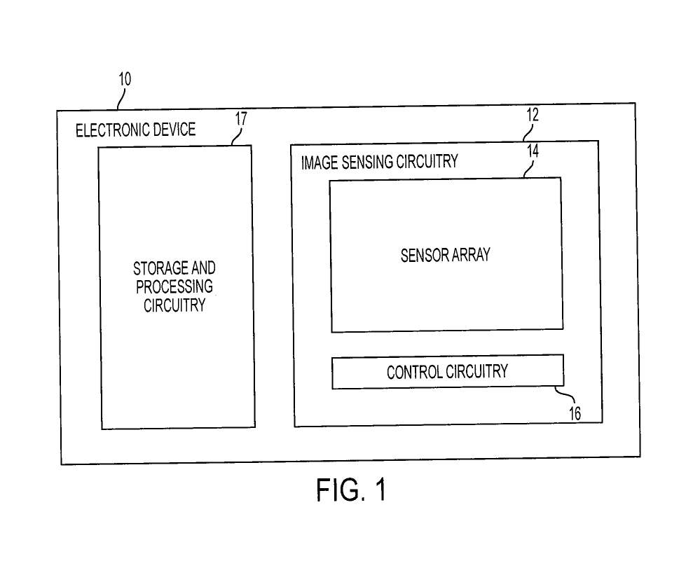

Referring first to FIG. 1, there is shown user device 10, which includes image sensing circuitry 12. User device 10 may be any electronic devices, such as a cellular telephone, a camera, a desktop computer, a laptop computer, a handheld gaming device, and a hybrid device that combines the functionality of multiple devices.

Device 10 may include image sensing circuitry 12. Image sensing circuitry 12 may include one or more integrated circuits and other components, as desired. For example, image sensing circuitry 12 may include an array of light sensitive pixels, such as sensor array 14. Each of the light sensitive pixels may convert incident light to an electrical signal. As one example, each of the pixels may be formed from a photodetector, such as a photodiode with a light sensitive region and may be configured to produce and store (e.g., accumulate) a charge proportional to the number of photons that impinge upon the light sensitive region. Image sensing circuitry 12 may also include control circuitry 16 that controls the operation of image sensing circuitry 12 and, in particular, that controls the operation of sensor array 14. As examples, control circuitry 16 may be used to reset light sensitive pixels in sensor array 14 (e.g., to remove accumulated image charges from the light sensitive pixels during a reset operation), to read out image data from the light sensitive pixel (e.g., to measure the accumulated charges of the pixels during a readout operation), to transfer accumulated charges to charge storage elements in the pixel array (e.g., to transfer the charge accumulated by each pixel into corresponding storage elements as part of a readout operation, or reset operation), etc. If desired, control circuitry 16 may include one or more analog-to-digital converters that can be used to convert analog signals from sensor array 14 into digital signals for processing.

Storage and processing circuitry 17 may be included in device 10. Storage and processing circuitry 17 may include one or more types of storage, such as hard disk drive storage, nonvolatile memory (e.g., flash memory or other electrically-programmable-read-only memory), volatile memory (e.g., battery-based static or dynamic random-access-memory), etc. Circuitry in storage and processing circuitry 17 may be used to control the operation of device 10 and image sensing circuitry 12. Processing circuitry 17 may be based on a processor such as a microprocessor and other integrated circuits. For example, storage and processing circuitry 17 may be used to run software on device 10, such as image processing applications, image display applications, operating system functions, power management functions, etc. Storage and processing circuitry 17 may be used to store image data such as high dynamic range images captured by sensor array 14 in image sensing circuitry 12. If desired, storage and processing circuitry 17 may be used to store image data during image processing operations.

Sensor array 14 may be formed from a plurality of pixels and may be organized using any architecture. As an example, the pixels of sensor array 14 may be organized in a series of rows and columns.

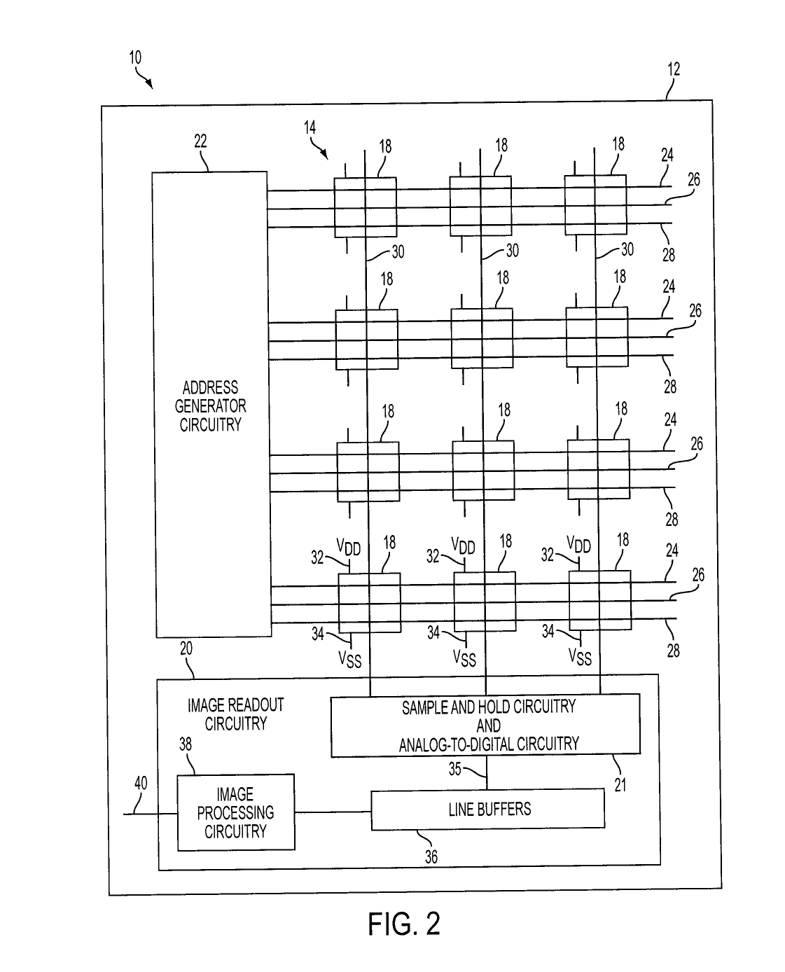

An example of an arrangement for sensor array 14 is shown in FIG. 2. As shown, device 10 may include an array 14 of pixels 18 coupled to image readout circuitry 20 and address generator circuitry 22. As an example, each of the pixels 18 in a row of array 14 may be coupled to address generator circuitry 22 by one or more conductive lines such as lines 24, 26, and 28. Array 14 may have any number of rows and columns. In general, the size of array 14 and the number of rows and columns in array 14 will depend on the particular implementation.

As one example, lines 24 may be reset lines that can be used to couple pixels 18 in a particular row to a power supply terminal such as positive power supply terminals 32, or ground power supply terminals 34 for resetting pixels 18. In one example, accumulated charges on pixels 18 may be erased by connecting pixels 18 to a power supply terminal, such as terminal 32 and/or 34, and allowing accumulated charges to dissipate into power supply lines in circuitry 12. If desired, circuitry 12 may include a global reset line that resets all pixels 18 in array 14 simultaneously. With this type of arrangement, reset lines 24 may be connected together to form a single global reset line.

Control lines 26 may be used to control transfer transistors in pixels 18. For example, control lines 26 may be transfer lines that are used to transfer accumulated charges in pixel 18 from light sensitive devices (e.g., photodiodes or other light sensitive devices) to storage elements (e.g., floating diffusion nodes or other storage elements) in pixels 18. When array 14 implements an electronic rolling shutter readout, the accumulated charges of a particular row may be read out shortly after the accumulated charges are transferred to the storage elements of pixels 18 in that particular row. If desired, the accumulated charges may be read out, as the accumulated charges are transferred to the storage elements.

If desired, control lines 26 may be connected together to form one or more global transfer lines. With this type of arrangement, a global transfer line 26 may be used to implement a global shutter scheme in which the accumulated charges from a plurality of pixels 18 in different rows of array 14 are simultaneously transferred to the respective storage elements in each of pixels 18. The accumulated charges may then be read out from the storage elements at a later time.

With one arrangement, transfer lines 26 may be used in conjunction with reset lines 24 during a reset operation of pixels 18. As one example, transfer signals on transfer lines 26 and reset signals on reset lines 24 may both be asserted simultaneously during a reset operation (e.g., so that the reset operation discharges accumulated charges from the storage elements and the light sensitive devices in each of pixels 18).

Control lines 28 may, for example, be connected to readout transistors in pixels 18 of array 14. With this type of arrangement, row select signals, sometimes referred to herein as readout signals, may be asserted on control lines 28 to connect a row of pixels 18 to image readout circuitry 20. For example, when row select signals are asserted on a given control line 28, pixels 18 associated with the given control line 28 may be coupled to image readout circuitry 20 through column readout lines 30. When a row of pixels 18 is coupled to image readout circuitry 20, signals representative of the accumulated charge on pixels 18 may be conveyed over column readout lines 30 to circuitry 20 (e.g., analog-to-digital converters that convert the signals from the image sensing pixels 18 into digital signals).

Address generator circuitry 22 may generate signals on control paths 24, 26 and 28, as desired. For example, address generator circuitry 22 may generate reset signals on paths 24, transfer signals on paths 26, and row select (e.g., row readout) signals on paths 28 to control the operation of array 14. Address generator circuitry 22 may be formed from one or more integrated circuits. If desired, address generator circuitry 22 and array 14 may be integrated together in a single integrated circuit.

Image readout circuitry 20 may include circuitry 21, line buffers 36 and image processing circuitry 38. Circuitry 21 may include sample and hold circuitry and analog-to-digital converter circuitry. As one example, circuitry 21 may be used to measure the charges of pixels 18 from a row of array 14 and may be used to hold the charges while analog-to-digital converters in circuitry 21 convert the charges to digital signals. The digital signals may be representative of the accumulated charges from pixels 18. The digital signals produced by the analog-to-digital converters of circuitry 21 may be conveyed to line buffers 36 (e.g., short-term storage) over path 35.

Line buffers 36 may be used to temporarily store digital signals from circuitry 21 for use by image processing circuitry 38. In general, image readout circuitry 20 may include any number of line buffers 36. For example, each line buffer 36 may hold digital signals representative of the charges read from each of pixels 18 in a given row of array 14.

Image processing circuitry 38 may be used to process the digital signals held in line buffers 36 to produce output data on path 40. If desired, the output data may include image data encoded in any format that can be stored in storage and processing circuitry 17 and displayed by device 10, or transferred to another electronic device, or other external computing equipment.

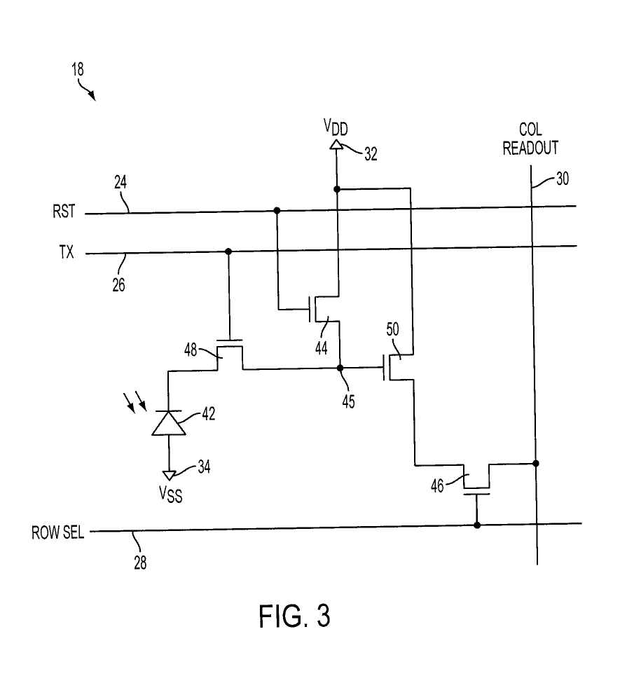

An example of an image sensing pixel 18 that may be used in array 14 of FIG. 2 is shown in FIG. 3. As shown, pixel 18 may include transistors, such as transistors 44, 46, 48 and 50. Pixel 18 may include a photosensitive device, such as photodiode 42. In general, it is desirable to maximize the light collecting area of the photosensitive device 42 relative to the total area of each pixel 18.

The photosensitive device 42 in each pixel 18 of array 14 may accumulate charge in response to incident light. With one arrangement, the time between a reset operation (in which the accumulated charge is reset) and a transfer operation (in which the accumulated charge is shifted to a storage element, such as floating diffusion node 45) may be referred to herein as an integration time, or an exposure time. The accumulated charge generated by the photosensitive device 42 may be proportional to the intensity of the incident light and the integration time. In general, relatively long integration times may be used to capture scenes with relatively low intensities (e.g., to ensure that the accumulated charge is sufficient to overcome noise in array 14) and relatively short integration times may be used to capture scenes with relatively high intensities (e.g., to ensure that the accumulated charge does not reach a saturation point).

Reset transistor 44 may be controlled by reset line 24. When reset signals (RST) on reset line 24 are asserted, transistor 44 may be turned on and, thereby allow accumulated charge on diffusion node 45 to flow into a power supply line (e.g., through power supply terminal 32). In one embodiment, transfer signals (TX) on transfer line 26 may be asserted simultaneously with the reset signals (RST) such that the accumulated charges on both the photosensitive element 42 and the diffusion node 45 are reset.

Transfer transistor 48 may be controlled by transfer line 26. When transfer signals (TX) on transfer line 26 are asserted, transistor 48 may be turned on and, thereby, allow accumulated charge from photodiode 42 to flow to other transistors in pixel 18, or to a storage element such as floating diffusion node 45. For example, transistor 48 may be turned on during a reset operation to allow the accumulated charge from photodiode 42 to flow through node 45 and transistor 44 to power supply terminal 32. As another example, transistor 48 may be turned on prior to a readout operation to allow the accumulated charge from photodiode 42 to flow to diffusion node 45. If desired, transistor 48 may be turned on during a readout operation to allow the accumulated charge from photodiode 42 to flow to the gate of transistor 50 (and control the operation of transistor 50).

Buffer transistor 50 and readout transistor 46 may be used during a readout operation of pixel 18. Readout transistor 46 may be controlled by row select (ROW SEL) signals on read line 28 and buffer transistor 50 may be controlled by the accumulated charge generated by photodiode 42 (which may be stored in diffusion node 45). When row select signals on line 28 are asserted, transistor 46 may be turned on and the accumulated charge from photodiode 42 may be used to control transistor 50. The voltage that the accumulated charge applies to the gate of transistor 50 may then determine the voltage of column readout (COL READOUT) line 30. Image readout circuitry 20 of FIG. 2 may then determine the voltage of the accumulated charge by sampling the voltage of line 30. If desired, the image readout circuitry 20 may utilize a correlated double sampling technique in which the reset level of pixel 18 is also measured.

With one arrangement, array 14 of FIG. 2 may use alternating pairs of rows in an interlaced pattern to obtain image data that can be used to capture high dynamic range scenes. With one arrangement, an interleaved multiple exposure technique may be utilized to capture high dynamic range images. With this type of arrangement, multiple exposures are captured using an array 14 that has pixels 18 formed in an interleaved pattern such that each image sensing pixel 18 receives only one of the exposures. For example, half of pixels 18 in array 14 may be integrated (i.e., exposed) for time T1 and half of pixels 18 in array 14 may be integrated for time T2. With this type of arrangement, array 14 may be used to capture two images of a scene using two different exposures that overlap at least partially in time. While typically described herein as including two exposures, in general, array 14 may be used to capture any number of exposures (e.g., three exposures, four exposures, five exposures, etc.) at least partially simultaneously.

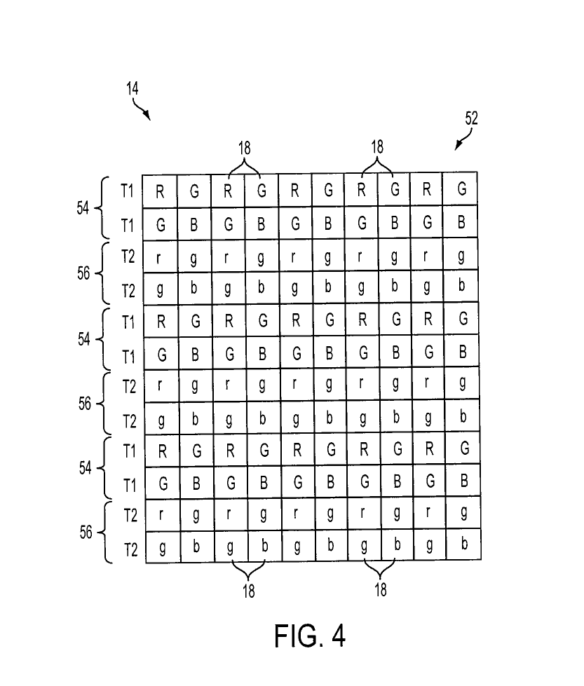

An embodiment for capturing high dynamic range images is illustrated in FIG. 4. The figure shows an illustrative color filter array (CFA) 52 which uses the well known Bayer filter pattern for red, blue, and green pixels (e.g., 50% green, 25% red, and 25% blue). As an example, color filter array 52 may be overlaid on top of the image sensor array 14. In the arrangement of FIG. 4, one or more pixels 18 may be located under each of the squares of the color filter array 52. In addition, when capturing a high dynamic range image, row pairs 54 may be integrated (i.e., exposed) for time T1 while row pairs 56 may be integrated for time T2, when array 14 is used to capture an image of a high dynamic range scene. With this type of arrangement, pixels 18 in row pairs 54 may be able to capture portions of a scene with low brightness levels while pixels 18 in row pairs 56 may be able to capture portions of the scene that have high brightness levels. If desired, the pixels in row pairs 54 and row pairs 56 may be exposed for the same amount of time when capturing a scene with low dynamic range.

The portions of filter array 52 corresponding to red, blue, and green pixels are denoted with the letters “r”, “b”, and “g”, respectively. The portions of filter array 52 corresponding to the longer integration time T1 are denoted with capitalized versions of these letters and the portions corresponding to the shorter integration time T2 are denoted with lowercase versions of these letters.

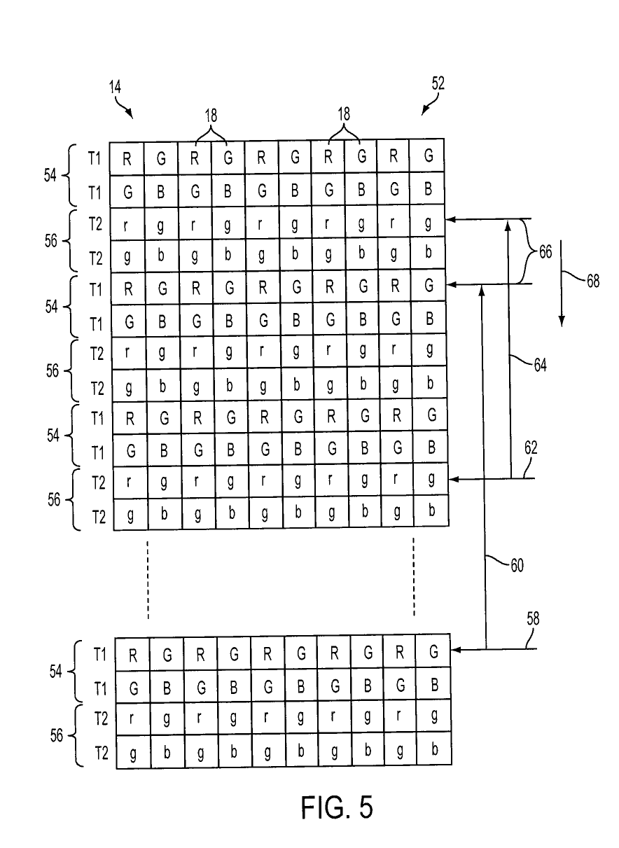

A diagram showing how two reset pointers may be used to initiate the first and second exposures at different times in array 14 is shown in FIG. 5. The first exposure (T1) may be initiated by reset pointer 58 (e.g., signals on one of the lines 24 of FIG. 2) and the second exposure (T2) may be initiated by reset pointer 62. Following an integration time illustrated by line 60 for T1 and line 64 for T2, pixels 18 may be readout (e.g., read transistors 46 may be turned on by readout pointers 66). This type of arrangement may be used in implementing an electronic rolling shutter in which the pointers progress through array 14 along direction 68 (as an example).

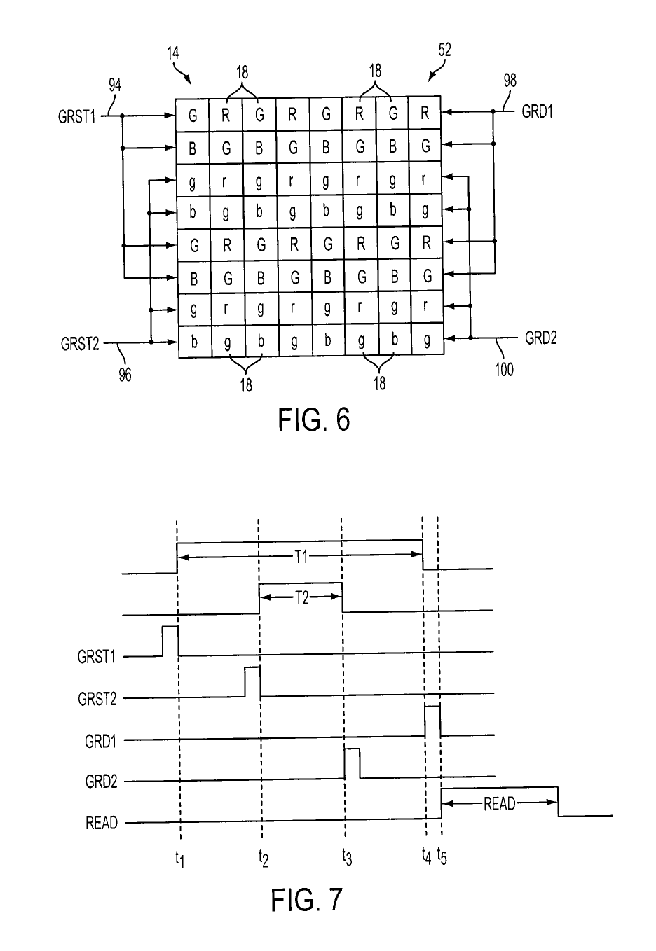

One potential way in which array 14 may implement a global shutter scheme is shown in FIG. 6. In the example of FIG. 6, a pair of global reset lines 94 and 96 and a pair of global transfer lines 98 and 100 may be used to control the operation of array 14. Global reset lines 94 and 96 may convey global reset signals such as GRST1 and GRST2 to array 14. Because there are two separate global reset lines 94 and 96, the arrangement of FIG. 6 allows two separate reset operations to occur. With one arrangement, the first reset operation may occur when GRST1 signals are asserted on line 94 and pixels 18 associated with a first exposure (T1) are reset. The second reset operation may occur when GRST2 signals are asserted on line 96 and pixels 18 associated with a second exposure (T2) are reset. The two reset operations may occur independently in time.

Global transfer lines 98 and 100 may convey global transfer signals such as GRD1 and GRD2 to array 14. Because there are two separate global transfer lines 98 and 100, the arrangement of FIG. 6 allows the occurrence of two separate transfer operations, in which accumulated charge in pixels 18 are transferred to storage elements in pixels 18 (e.g., diffusion nodes in pixels 18). With one arrangement, the first transfer operation may occur when GRD1 signals are asserted on line 98 and the accumulated charges of pixels 18 associated with the first exposure (T1) are transferred to storage elements in pixels 18. The second transfer operation may occur when GRD2 signals are asserted on line 100 and the accumulated charges of pixels 18 associated with the second exposure (T2) are transferred to storage elements in pixels 18. The two transfer operations may occur independently in time.

Because there are two global reset lines and two global transfer lines, the arrangement of FIG. 6 allows a high degree of flexibility in selecting how the first and second exposures of array 14 (i.e., T1 and T2) overlap in time. For example, as shown in FIG. 7, pixels 18 of the first exposure T1 may be reset by GRST1 signals on line 94 at time t1 (which effectively initiates the T1 exposure at time t1), pixels 18 of the second exposure T2 may be reset by GRST2 signals on line 96 at time t2 (which effectively initiates the T2 exposure at time t2), transfer signals GRD2 may be asserted at time t3 (effectively ending the T2 exposure), transfer signals GRD1 may be asserted at time t4 (effectively ending the T1 exposure), and readout signals READ may begin to be asserted at time t5 to begin reading out image data from array 14. Because of the flexibility available in this arrangement, the second exposure may occur in the middle (time-wise) of the first exposure or may occur at any other time.

Once image sensor array 14 has been used to capture image data associated with a scene that has a high dynamic range (e.g., a range that exceeds a linear response of a single image sensing pixel such as pixel 18), the image data may be used to produce a high dynamic range image. The high dynamic range image may be stored in storage and processing circuitry 17 and, if desired, may be conveyed over a communications path to external computing equipment by communications circuitry in device 10. In one embodiment, image data produced by sensor array 14 may include two or more interlaced images interleaved together. As an example, the first image may include all of the even row pairs of sensor array 14 and may be captured using a first exposure (T1) and the second image may include all of the odd row pairs of array 14 and may be captured using a second exposure (T2).

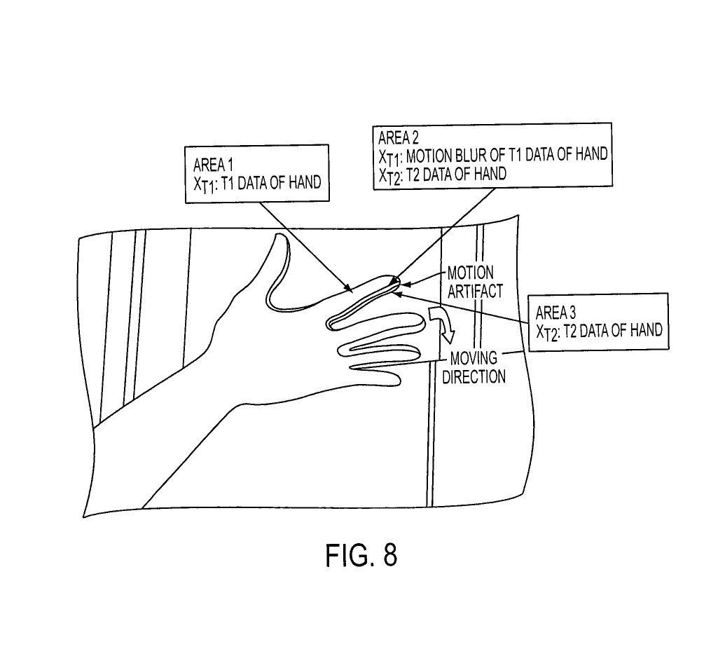

Having described examples of methods for high dynamic range image capture, these methods suffer from motion artifacts due to each exposure capture occurring at different times. In other words, objects that move in the scene are captured at different spatial locations in each image. It will be appreciated, however, that since each exposure data is captured within one frame, it reduces the motion artifact when compares to multiple-frame capture approaches. However, when the moving object and its corresponding background has very different brightness level, such as a moving hand in a strong window lighting background, as shown in FIG. 8, the motion artifact is still present in the reconstructed image. This motion artifact is disturbing to human eyes when viewing a captured HDR video.

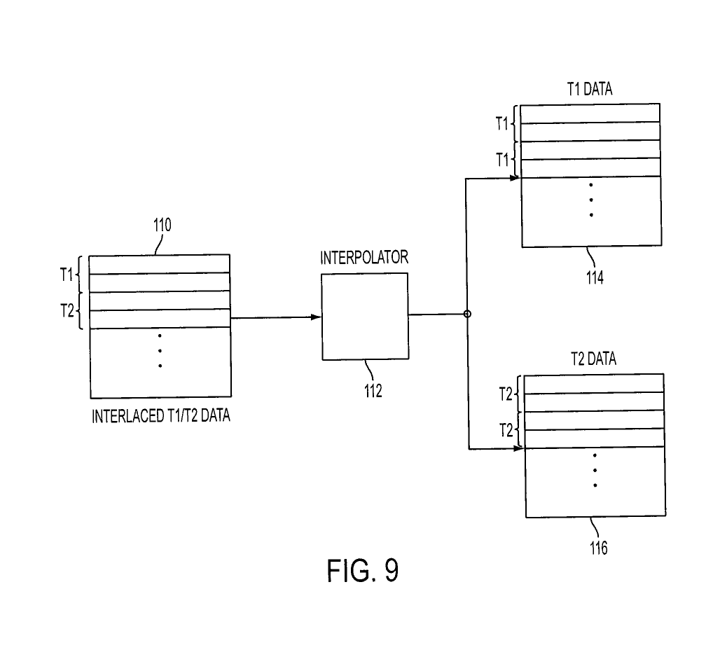

A reconstructed image starts with separate T1 data and T2 data, as shown in FIG. 9. As shown, interpolator 112 receives interlaced T1/T2 data, designated as 110, and outputs separate sets of T1 data and T2 data, designated as 114 and 116, respectively. The T1 data and T2 data are each full sets of data for each pixel location in the image array (for example, sensor array 14 in FIGS. 1 and 2).

After obtaining full T1/T2 data, the reconstructed data (Rec) is obtained by using the corresponding reconstruction function. The reconstruction function uses pre-defined threshold levels, S₁, S₂, etc., that determine from which output pixel the input T1 data and/or T2 data come from. The following formula shows an example of a reconstruction method:

$$Rec = \{ \begin{matrix}{X}_{T 1} & {X}_{T 1} < S 1 \\ ( 1 - {k}_{c} ) * exp\_ratio * {X}_{T 2} + {k}_{c} {X}_{T 1} & S 1 \leq {X}_{T 1} < S 2 \\ exp\_ratio * {X}_{T 2} & S 2 \leq {X}_{T 1}\end{matrix}$$

where X_{T1} and X_{T2} are the corresponding T1 data and T2 data, respectively.
The exp_ratio is the ratio between exposure time of T1 and T2.
The S1 and S2 are pre-selected thresholds.
The kc is a weighting constant determined by the following equation:

$${k}_{c} = \frac{{X}_{T 1} - S 1}{S 2 - S 1}$$

Referring again to FIG. 8, as an example, it is possible to generate three different brightness areas after image reconstruction. As the hand moves downwardly against the brighter background of the window, three areas are shown in the figure, in which each area has different reconstructed data (Rec). They are as follows:
Area 1 contains T1 and T2 data of the moving hand. Since X_{T1}<S1, the Rec=X_{T1}. The reconstruction function outputs T1 data of the moving hand.
Area 3, contains T1 data of the background and T2 data of the moving hand. The T1 data of the moving hand has not yet arrived. Since S2≦X_{T1} (strong background lighting), the Rec=exp_ratio*X_{T2}. The brightness level of area 3 is slightly different from Area 1.
Area 2 contains a motion blur of T1 data of the moving hand and T2 data of the moving hand. Since S1≦X_{T1}<S2 (X_{T1} is the mixed data of hand and background due to motion blur), the Rec=(1−k_{c})*exposure_ratio*X_{T2}+k_{c} X_{T1}. The output of area 2 is brighter than Area 1 and Area 3. This special motion artifact (a bright area around the edge of the hand) would appear in the reconstructed image.

In order to reduce the above motion artifact (namely, a moving object in front of a bright background), the present invention detects, smoothes and corrects the HDR image.

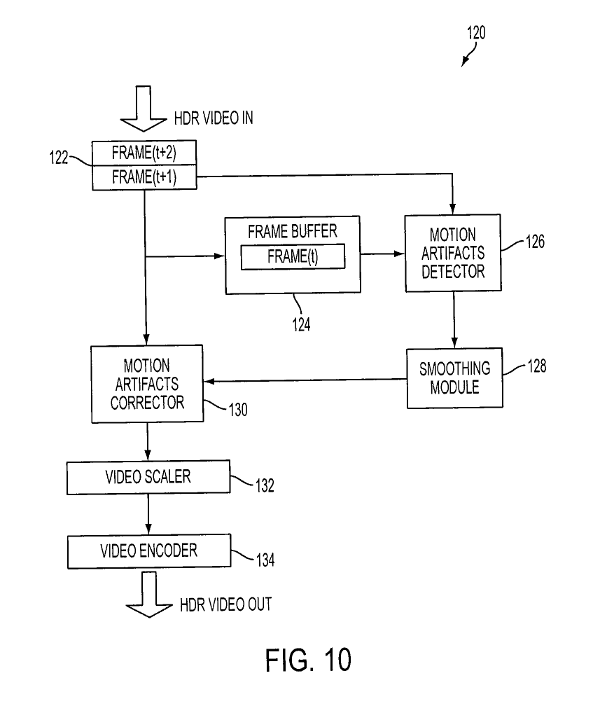

Referring now to FIG. 10, there is shown an example of an artifact correction system, generally designated as 120. As shown, system 120 receives the captured HDR video from consecutive frames 122. These frames include: Frame (t+2) and Frame (t+1), in which Frame (t+1) is defined as the current frame and Frame (t+2) is defined as the next frame. The previous frame, Frame (t), is shown stored in frame buffer 124.

System 120 includes motion artifacts detector 126, smoothing module 128 and motion artifacts corrector 130. The motion artifacts detector, smoothing module and motion artifacts corrector are described further below. After correction of the motion artifacts, system 120 scales and encodes (if desired) the HDR video, using video scaler 132 and video recorder 134, respectively.

It will be appreciated that system 120 may be part of application software for post processing of HDR captured video. System 120 may also be implemented in special storage and processing circuitry 17, shown in FIG. 1.

The motion artifacts detector 126 uses the following three properties to detect motion artifacts:

(1) The luma difference between the current frame and the previous frame is larger than a predetermined threshold value.

(2) The T1 values of motion artifact pixels satisfy: S1≦X_{T1}<S2.

(3) The surrounding area of the motion artifact pixel includes strong brightness pixels (either in the background or in the moving object).

Assuming that the luma value of a pixel in the current frame and previous frame located at (x0, y0) is Y_{cur} (x0,y0) and Yₚᵣₑ (x0,y0), respectively, then a motion artifact map, M_Arti, may be generated based on the following formula:

$$M\_Arti ( x 0 , y 0 ) = \{ \begin{matrix}1 , & \begin{matrix}if \vert {Y}_{cur} ( x 0 , y 0 ) - {Y}_{pro} ( x 0 , y 0 ) \vert > diff\_thre \& \\ V 1 \leq {Y}_{cur} ( x 0 , y 0 ) < V 2 \& M > num\_thre\end{matrix} \\ 0 , & otherwise\end{matrix}$$

where diff_thre, V1, V2 and num_thre are pre-selected parameters.

Furthermore, assume a window W1 of N1×N1 size, which is centered at (x0, y0), and M is the total number of pixels within W1 that satisfies the following:

Y_{cur}(Xi, Yi)>V2 or Yₚᵣₑ(Xi, Yi)>V2

where (Xᵢ, Yᵢ) [symbol] W1

After generating the motion artifact map, smoothing module 128 provides a smoothing operation. The purpose of the smoothing operation is to enlarge the motion artifact detected area, and reduce isolated false detected pixels.

Assuming a window W2 with N2×N2 size that is centered at (x0, y0), the output of the motion artifact map after smoothing becomes:

$${M\_Arti}^{′} ( x 0 , y 0 ) = \{ \begin{matrix}1 , & if \sum M\_Arti ( {x}_{i} , {y}_{i} ) > mot\_thre , ( {x}_{i} , {y}_{i} ) ∈ W 2 \\ 0 , & otherwise\end{matrix}$$

where mot_thre is a predetermined threshold value.

After smoothing the detected motion artifacts, motion artifacts corrector 130 applies a multistage filter to the motion artifact pixels. This is implemented in order to reduce the motion artifacts and preserve image details. This filter, however, is applied in the YCbCr domain. Therefore, for RGB data, a conversion between RGB to the YCbCr domain is first required. (The video encoder 134 may be used to convert the images back to RGB).

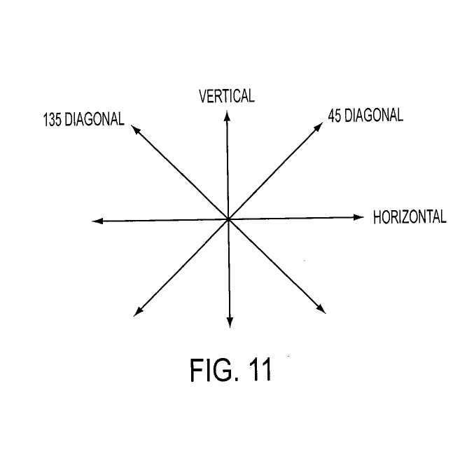

For the Y channel, four 1D median filters, along the directions of horizontal, vertical, 135 degree diagonal and 45 degree diagonal (as shown in FIG. 11) are applied first.

Assuming that the 1D window has a size of 2*w+1, which is centered at (x0, y0), then the four median filter outputs for a motion artifacts pixel located at (x0, y0) is as follows:

Y′ₕₒᵣ (x0, y0)=median(Y(x0−w, y0), Y(x0−w+1, y0), . . . , Y(x0−1,y0), Y(x0, y0), Y(x0+1, y0), . . . , Y(x0+w−1, y0), Y(x0+w, y0));

Y′ᵥₑᵣ(x0, y0)=median(Y(x0, y0−w), Y(x0, y0−w+1), . . . , Y(x0, y0−1), Y(x0, y0), Y(x0, y0+1), . . . , Y(x0, y0+w−1), Y(x0, y0+w));

Y′_{45 diag}(x0, y0)=median(Y(x0+w, y0−w), Y(x0+w−1, y0−w+1), . . . , Y(x0+1,y0−1), Y(x0, y0), Y(x0−1, y0+1), . . . , Y(x0−w+1, y0+w−1), Y(x0−w, y0+w));

Y′_{135 diag}(x0, y0)=median(Y(x0−w, y0−w), Y(x0−w+1, y0−w+1), . . . , Y(x0−1,y0−1), Y(x0, y0), Y(x0+1, y0+1), . . . , Y(x0+w−1, y0+w−1), Y(x0+w, y0+w));

The final output is the mean of the above four 1D median outputs, as follows:

Y^{′}_{final}(x0, y0)=(Y′ₕₒᵣ+Y′ᵥₑᵣ+Y′_{45 diag}+Y′_{135 diag})/4

For the Cb and Cr channels, the output is the mean of the pixel values inside the window W3, where W3 is a 2D window centered at (x0, y0) with a size of (2w+1)*(2w+1). These outputs are as follows:

Cb′_{final}(x0, y0)=ΣCb(xᵢ, yᵢ)/((2w+1)*(2w+1)) for (xᵢ, yᵢ) ∈ W3.

and

Cr′_{final}(x0, y0)=ΣCb(xᵢ, yᵢ)/((2w+1)*(2w+1))

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A method of correcting motion artifacts comprising the steps of :
receiving current and previous image frames, each having first and second exposure data at times T1 and T2, respectively;
detecting pixels in a predetermined area having motion artifacts in the first and second exposure data; and
correcting the pixels in the predetermined area.

2. The method of claim 1 wherein the step of detecting includes:
determining that a luma difference between the current image frame and previous image frame is larger than a first predetermined threshold; and
determining that the first exposure includes pixels having intensity values between second and third predetermined thresholds.

3. The method of claim 1 wherein the step of detecting includes:
determining that a total number of pixels in the predetermined area have intensity values greater than a predetermined threshold in either the current image frame, or the previous image frame.

4. The method of claim 1 including the step of :
enlarging the predetermined area having motion artifacts by smoothing the detected pixels.

5. The method of claim 1 wherein the step of correcting includes:
converting values of the detected pixels from an RGB domain into a YCbCr domain; and
filtering the converted values of the detected pixels.

6. The method of claim 5 wherein filtering includes:
providing a filter to a one-dimensional window centered at a pixel located at (x0, y0) in a Y channel.

7. The method of claim 6 wherein the filter includes:
two one-dimensional filters along horizontal and vertical directions with respect to the one-dimensional window.

8. The method of claim 6 wherein the filter includes:
two one-dimensional filters along 135 degree and 45 degree diagonals with respect to the one-dimensional window.

9. The method of claim 5 wherein filtering includes:
providing a filter to a two-dimensional window centered at a pixel located at (x0, y0) in at least one of a Cb channel and a Cr channel.

10. The method of claim 9 wherein the filter provides a mean value of pixel intensities within the two-dimensional window.

11. The method of claim 1 wherein
the time T1 is of greater duration than the time T2, and
the time T2, at least partially, overlaps the time T1.

12. The method of claim 1 wherein the first and second exposure data is interleaved and interpolated to provide separate T1 exposure data and T2 exposure data.

13. A method of correcting motion artifacts in a current image frame comprising the steps of :
exposing the current image frame to first and second interleaved exposures, wherein the first interleaved exposure includes T1 exposure data, and the second interleaved exposure includes T2 exposure data;
detecting pixels in a predetermined area of the current image frame having motion artifacts; and
correcting the pixels in the predetermined area.

14. The method of claim 13 including the step of :
exposing a previous image frame to a previous first and second interleaved exposures; and
wherein the step of detecting includes the steps of:
determining that luma differences between pixels in the current and previous image frames are larger than a first predetermined threshold; and
determining that the T1 exposures data includes pixels having intensity values between second and third predetermined thresholds.

15. The method of claim 14 wherein the steps of determining includes:
counting if the number of pixels in the predetermined area exceeds a fourth threshold value.

16. The method of claim 13 wherein the step of correcting includes:
filtering the detected-pixels using multiple one-dimensional windows centered at (x0, y0).

17. The method of claim 13 wherein the step of correcting includes:
filtering the detected-pixels using a two-dimensional window centered at (x0, y0).

18. An image processor for correcting motion artifacts, the processor executing the steps of:
receiving current and previous image frames, each frame having T1 exposure data and T2 exposure data, wherein the T2 exposure data overlaps the T1 exposure data;
interpolating the T1 exposure data and the T2 exposure data to obtain separate T1 data and T2 data for the current and previous image frames;
selecting pixels in a predetermined area in each of the current and previous image frames;
determining that luma differences between the pixels in the current image frame and the pixels in the previous image frame are larger than a first predetermined threshold;
determining that the T1 data for the current image frame includes pixels in the predetermined area having intensity values between second and third predetermined thresholds; and
correcting the pixels in the predetermined area of the current image frame.

19. The image processor of claim 18 wherein correcting the pixels includes:
smoothing the pixels in the predetermined area of the current image frame; and
filtering the pixels by obtaining mean values calculated along multiple directions in a one-dimensional window centered at (x0, y0).

20. The image processor of claim 18 wherein correcting the pixels includes:
smoothing the pixels in the predetermined area of the current image frame; and
filtering the pixels by obtaining a mean value calculated in a two-dimensional window centered at (x0, y0).
